(19) United States
(12) Patent Application Publication
(10) Pub. No.: US 2023/0014159 A1
(43) Pub. Date: Jan. 19, 2023

(54) Internal Combustion Engine Air Intake System for Avoiding Turbocharger Surge

(71) Applicant: Southwest Research Institute, San Antonio, TX (US)

(72) Inventor: Edward M Smith, III, San Antonio, TX (US)

(21) Appl. No.: 17/375,440

(22) Filed: Jul. 14, 2021

(51) Int. Cl. F02B 37/12; F02B 39/10

(52) U.S. Cl. CPC F02B 37/12; F02B 39/10; F02B 2037/122; F02B 2037/125

(57) ABSTRACT

An improved turbocharged internal combustion engine, having an air intake system that avoids compressor surge. A positive displacement blower is installed on the air intake line between the compressor and the engine cylinders. The blower has variable speed control so that its speed may be modulated. A controller controls the speed of the blower, such that the average pressure ratio across the blower is 1.0 across each engine cycle.

### TECHNICAL FIELD OF THE INVENTION

This invention relates to internal combustion engines, and more particularly to turbocharged air intake systems for such engines.

### BACKGROUND OF THE INVENTION

A supercharger is an air compressor that increases the pressure or density of air supplied to an internal combustion engine. This gives each intake cycle of the engine more oxygen, letting it burn more fuel and do more work, thus increasing the power output. Supercharging is a well understood method of increasing the performance of internal combustion engines.

Power for the supercharger can be provided mechanically by means of a belt, shaft, or chain connected to the engine's crankshaft. Common usage restricts the term supercharger to mechanically driven units; when power is instead provided by a turbine powered by exhaust gas, the supercharger is known as a turbocharger.

Superchargers having a centrifugal compressor (such as turbochargers) are typically used when high compressor efficiency is desired. The usable flow range of centrifugal compressors is limited by surge and choke conditions, encountered when the air flow at a given pressure ratio is too low or too high, respectively.

When the engine has unsteady intake flow characteristics, such as a four-stroke engine with four or fewer cylinders, surge behavior is exacerbated. As internal combustion engine vehicles become more efficient there is a need to reduce the engine size. Such engine downsizing is often accomplished by reducing cylinder count.

Another engine condition that can result in unsteady intake to the intake manifold is an engine operating strategy known as cylinder deactivation (CDA). With CDA, fuel and valve actuation are shut off to one or more cylinders at low loads to reduce engine pumping losses and to increase exhaust temperature. As cylinders are deactivated, intake flow is reduced and the flow rate becomes unsteady. This can lead to compressor surge behavior.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 illustrates an internal combustion engine having a mechanically driven blower in accordance with the invention.

FIG. 1A illustrates an internal combustion engine having an electrically driven blower in accordance with the invention.

FIG. 2 illustrates an example of compressor surge margin with the blower.

FIG. 3 illustrates an example of compressor surge margin without the blower, with the same engine as FIG. 2.

FIG. 4 illustrates instantaneous compression and expansion accomplished by the blower during engine cycles.

FIG. 5 illustrates an example of reduction in intake volume flow pulsation amplitude across the blower.

### DETAILED DESCRIPTION OF THE INVENTION

The following description is directed to improving performance of turbocharged internal combustion engines. A positive displacement blower is placed in the air intake path between the turbocharger's compressor and the engine's intake manifold. As explained below, the blower is operated in a manner that reduces the likelihood of engine surge.

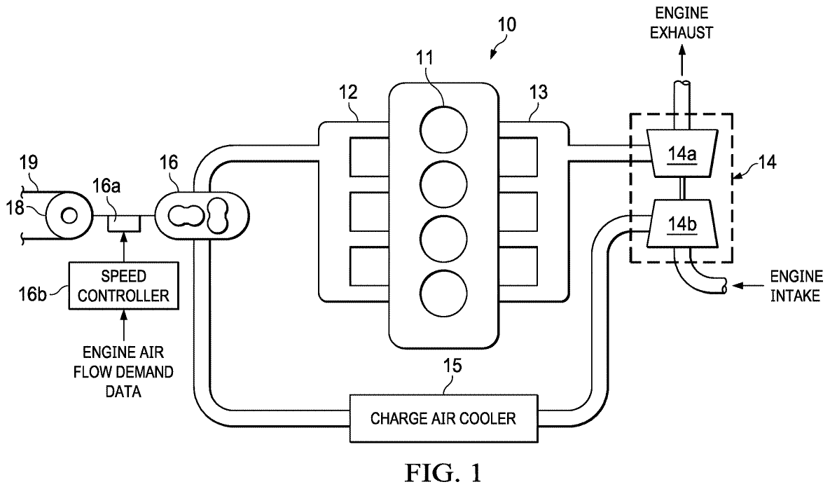

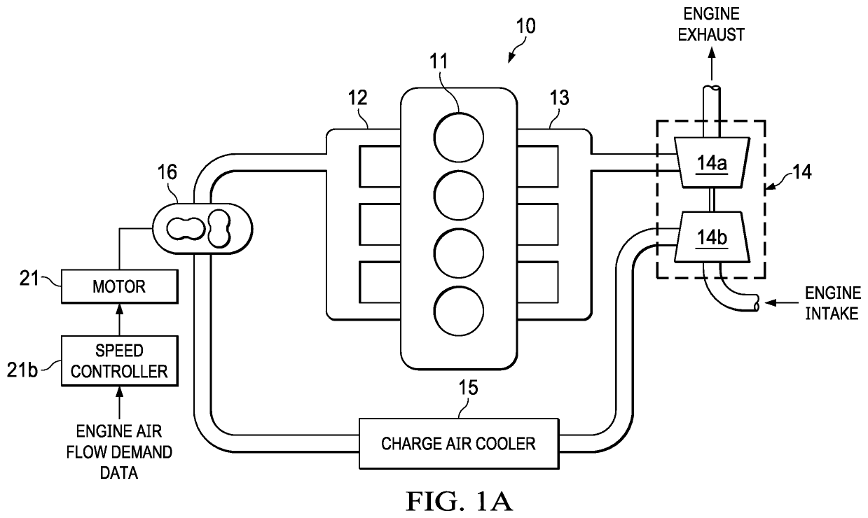

FIG. 1 illustrates a turbocharged internal combustion engine 10 having an air intake system in accordance with the invention. Engine 10 is illustrated representatively by four cylinders 11. Only those parts of engine 10 relevant to the invention are shown; it is understood that an internal combustion engine has many other elements.

In the example of this description, engine 10 is a four-stroke diesel engine. However, the invention is useful with other engine configurations, such as engines fueled with other fuels or with two-stroke engines.

An intake manifold 12 provides intake air to the cylinders 11. Exhaust from combustion within the cylinders 11 exits the engine 10 via an exhaust manifold 13.

Engine 10 is equipped with a turbocharger 14. The turbine 14a of the turbocharger is driven by exhaust from the engine. Turbine 14a drives a centrifugal compressor 14b, which compresses intake air entering the compressor 14b. The compressed air is then cooled by a cooler 15.

A positive displacement blower 16 is placed on the air intake path between compressor 14b and the intake manifold 12. An example of a suitable positive displacement blower 16 is a Roots-type blower. In the example of FIG. 1, where the air intake path has a cooler 15, blower 16 is downstream of the cooler.

In the embodiment of FIG. 1, blower 16 is mechanically driven. Like other peripheral devices in an automotive engine, blower 16 may be mechanically coupled to the engine. In this example, blower 16 is driven via pulley 18 and belt 19, but may alternatively be driven by various mechanical means such as are used to drive other peripheral devices. A variable speed transmission 16a provides a means to modulate the speed of blower 16. An example of a suitable variable speed transmission is a continuously variable transmission.

FIG. 1A illustrates an alternative embodiment in which blower 16 is driven electrically with an electric motor 21. Motor 21 is a variable speed motor, operable to modulate the speed of blower 16 as described herein.

Referring to the embodiments of both FIGS. 1 and 1A, the speed of blower 16 is modulated such that the cycle-average pressure ratio across blower 16 is 1.0. Either variable speed motor 21 or variable speed transmission 16a allow the speed of blower 16 to be modulated in this manner.

A controller 16b or 21 controls the speed of blower 16, based on air flow demands of the engine. This air flow demand data may be measured directly using a delta pressure sensor across blower 16. Alternatively, air flow demand data may be obtained indirectly based on air flow data already measured or calculated by an engine control system. Controller 16b or 21 receives the air flow demand data and determines the blower speed that will maintain an engine cycle average of 1.0 across the blower.

Because the speed of blower 16 is modulated such that the cycle-average pressure ratio across it is 1.0, blower 16 provides no additional compression. Used in this manner, blower 16 smooths out the intake flow. It instantaneously compresses air to the intake manifold during periods in the engine cycle when intake valves are closed. It instantaneously expands air from the compressor when an intake valve is open and air is free to flow from the intake manifold and into the cylinder.

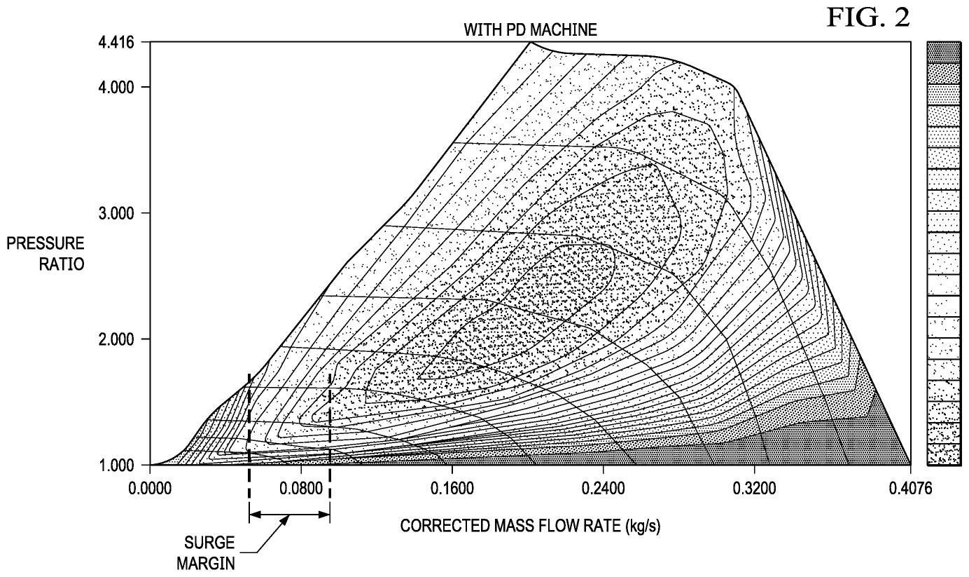

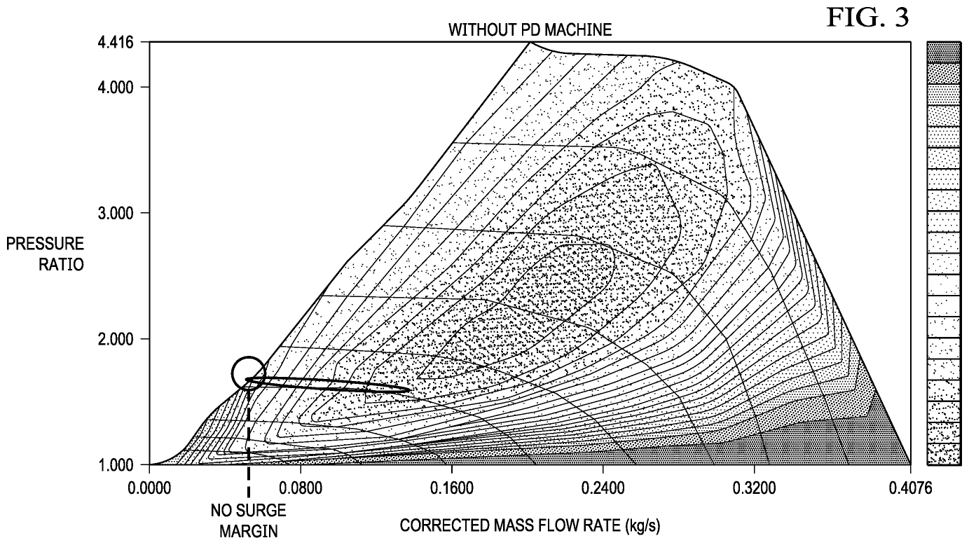

FIG. 2 illustrates an example of improved surge margin of a compressor 14b in an engine having a blower 16 operating as described above. The engine tested was a 4-stroke 4-cylinder turbocharger diesel engine operating at 1000 rpm with 12.5 bar BMEP. FIG. 3 illustrates how, for the same engine, the surge margin is absent without the operation of blower 16.

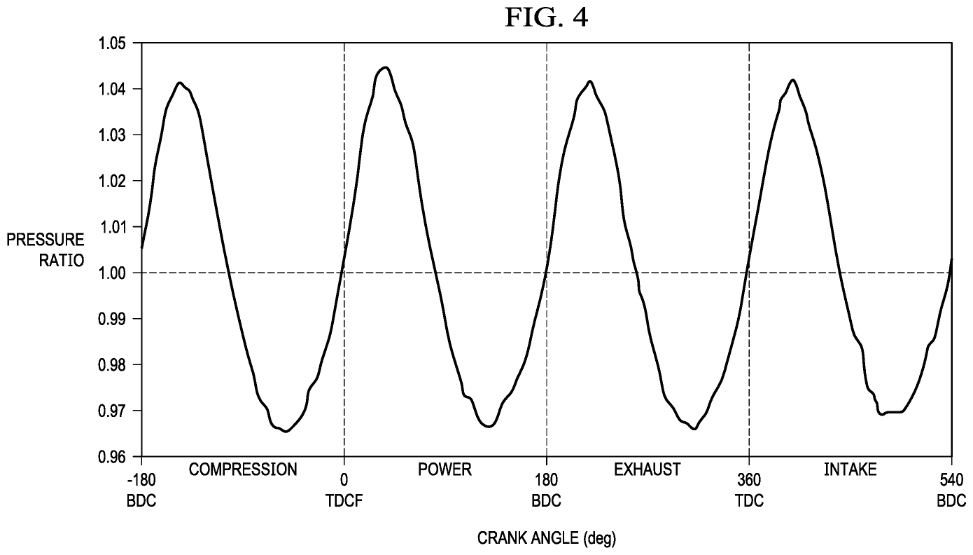

FIG. 4 illustrates an example of instantaneous compression and expansion provided by blower 16. The example engine is the same as that of FIGS. 1 and 1A. The engine intake flow is illustrated through one engine cycle.

When intake flow is low, blower 16 compresses the intake. When intake flow is high, blower 16 expands the flow. The engine cycle average pressure ratio is 1.0.

More specifically, at some instantaneous moments in the engine cycle, the blower 16 is compressing the air flow (above the dotted line) at which point work is done to the air by the blower. At other moments in the cycle, the air flow is expanding across the blower 16, at which point work is being done by air to the blower. Averaged out over an engine cycle, the power required to run the blower at a cycle average pressure ratio of 1.0 is low because the net work done to the air flow is near zero. Only friction losses plus some thermodynamic inefficiencies in the compressor need be overcome by input power to the blower 16.

Thus, because blower 16 can expand as well as compress gases flowing through it, the net power required to operate blower 16 at a cycle-average pressure ratio of 1.0 is only its mechanical friction. In practical application, there are some thermodynamic inefficiencies in both the compression and expansion processes to be overcome, in addition to the mechanical friction. Nevertheless, the power consumption of blower 16 is quite low. This particularly distinguishes the use of blower 16 from conventional superchargers.

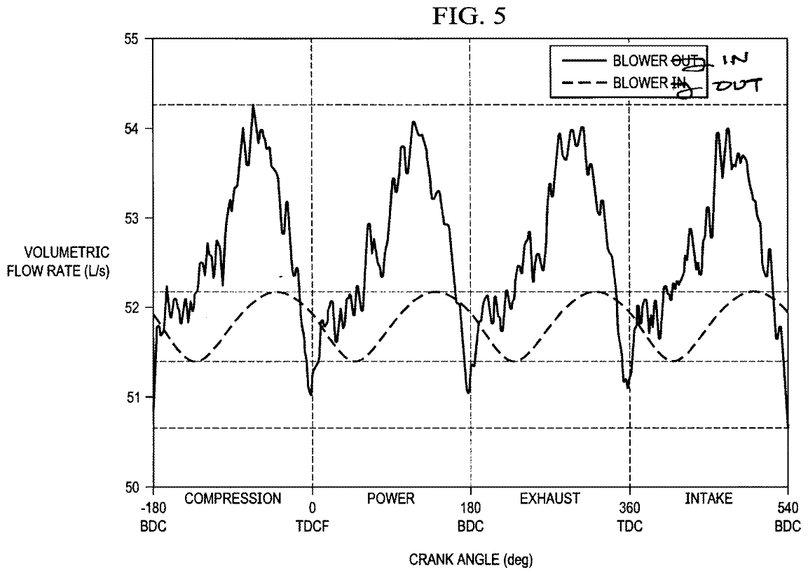

FIG. 5 illustrates the reduction in intake volume flow pulsation amplitude while using the intake system of FIG. 1 or 1A. The example engine is the same as that of the engine tested in FIGS. 2-4. The engine volumetric flow rate is illustrated through one engine cycle.

If blower 16 is equipped with independent speed control, such as by being electrically driven, it can confer additional benefits on the engine. These benefits may include reduction in transient boost lag, adding boost at speeds and loads where the turbocharger in ineffective, and recovering energy during engine throttling.

The intake system of FIG. 1 is useful for any turbocharged engine having periodic disruptions of intake flow. One category of such engines is four-stroke engines with an even firing order running on fewer than all cylinders. Engines with a cylinder deactivation strategy are a subset of this category.

1. An improved internal combustion engine, the engine having a number of cylinders and a turbocharger having a compressor and a turbine, providing an air intake flow from the compressor to engine intake valves, the engine further having two-stroke or four-stroke engine cycles, comprising:
a positive displacement blower placed on the air intake line between the compressor and the cylinders;
wherein the positive displacement blower is configured to displace intake flow from an inlet thereof to an outlet thereof;
wherein the positive displacement blower has variable speed control; and
a controller for controlling the speed of the blower, such that the blower displacement is modulated within each engine cycle depending on open or closed positions of the intake valves such that a pressure ratio given by a pressure at the outlet divided by a pressure at the inlet is an average of 1 across each cycle of the engine.

2. The improved internal combustion engine of claim 1, wherein the blower is mechanically driven by a mechanical coupling to the engine, the mechanical coupling having a variable speed transmission.

3. The improved internal combustion engine of claim 1, wherein the blower is driven with a variable speed electric motor.

4. The improved internal combustion engine of claim 1, wherein the positive displacement blower is a Roots-type blower.

5. The improved internal combustion engine of claim 1, wherein the engine is a four-stroke engine running on fewer than all cylinders.

6. The improved internal combustion engine of claim 1, wherein the air intake path is equipped with a cooler and the positive displacement blower is downstream of the cooler.

7. The improved internal combustion engine of claim 1, wherein the controller controls the speed of the blower based on engine air flow demand data.

8. (canceled)

9. A method of avoiding turbocharger surge in an internal combustion engine, the engine having a number of cylinders and a turbocharger having a compressor and a turbine, with an air intake path from the compressor to the cylinders, the engine further having two-stroke or four-stroke engine cycles, comprising:
installing a positive displacement blower on the air intake line between the compressor and the cylinders;
wherein the positive displacement blower is configured to displace intake flow from an inlet thereof to an outlet thereof;
wherein the positive displacement blower has variable speed control; and
installing a controller for controlling the speed of the blower, the controller operable to modulate the blower displacement within each engine cycle depending on open or closed positions of the intake valves such that a pressure ratio given by a pressure at the outlet divided by a pressure at the inlet is an average of 1 across each cycle of the engine.

10. The method of claim 9, wherein the blower is mechanically driven by a mechanical coupling to the engine, the mechanical coupling having a variable speed transmission.

11. The method of claim 9, wherein the blower is driven with a variable speed electric motor.

12. The method of claim 9, wherein the positive displacement blower is a Roots-type blower.

13. The method of claim 9, wherein the engine is a four-stroke engine running on fewer than all cylinders.

14. The method of claim 9, wherein the air intake path is equipped with a cooler and the positive displacement blower is downstream of the cooler.

15. The method of claim 9, wherein the controller controls the speed of the blower based on engine air flow demand data.

16. (canceled)
